(19) United States
(12) Patent Application Publication
(10) Pub. No.: US 2010/0245063 A1
(43) Pub. Date: Sep. 30, 2010

(54) Santar

(75) Inventor: Walter Leon Brown, Lemon Grove, CA (US)

Correspondence Address: WALTER LEON BROWN, 140 Santa Barbara Ave., Modesto, CA, 95354-2702, US

(73) Assignee: Walter Leon Brown, Lemon Grove, CA (US)

(21) Appl. No.: 12/383,617

(22) Filed: Mar. 30, 2009

(51) Int. Cl. B60Q 1/00

(52) U.S. Cl. 340/425.5; 340/686.6

(57) ABSTRACT

SANTAR is a means of wireless communication that electronically sense, and detect other vehicles in proximity using a common electromagnetic frequency, Receive, and transmit proximity data between vehicles in proximity. Display proximity data to the vehicle operators, on a sensory graphics display. Enable the vehicle operators to view and transmit a common greeting and/or message to the other vehicle operators in proximity through a sensory responsive graphic display. Enable the driver to choose which vehicle, or vehicles to receive communications from, and allows a secure direct inter vehicular wireless link to be established between vehicle operators for the purpose of transmitting voice, and other data between vehicle operators, and other vehicle occupants

### CROSS REFERENCE TO RELATED APPLICATIONS

(a) This application relates to the application for USPTO customer: mailing date: Sep. 12, 2008 to: Walter Leon Brown at 3590 Sweetwater Way. Lemon Grove, Calif. 91945-2030. USPTO Customer Number: 000084757

### STATEMENTS REGARDING FEDERALLY FUNDED RESEARCH

NOT APPLICABLE

### SEQUENCE LISTING OR PROGRAMS

NOT APPLICABLE

### BACKGROUND OF INVENTION

(a) This invention relates to wireless communications technology, specifically, wireless communications technologies as they can be applied to, and used by the Auto Industry in providing a means of direct communications between drivers of separate vehicles, while the vehicles are in motion, or at rest.

### PRIOR ART

(a) The importance of direct communication between drivers cannot be overstated; however, at present, horns, turn signals, and hand gestures are the only means of communicating with unknown persons in proximity. But these modes of communication have severe limit

(b) Horns can only get someone's attention, and turn signals can only indicate intent to turn in another direction.

(c) Hand gestures are even more limited in their ability to relay any message of meaning, and are subject to be misinterpreted.

(d) Other available means of communication between drivers is the use of the cell phone; however, the cell phone number of the other individual must be known to use this means of communication.

(e) Whereas, the means to directly select and communicate with a driver in proximity is a means of communication that is of great particle use, technically possible, and an idea whose time has come.

### ADVANTAGES

(a) Accordingly, besides the objects and advantages of the selective direct inter vehicular wireless communication system described in my above patent: titled, Santar, several objects and advantages of the present invention are:

(b) To provide an immediate means for drivers, and other vehicle occupants to communicate directly with each other.

(c) To provide a means to inform drivers in proximity of any potential problem with their vehicle, or other possible hazards.

(d) To provide a means to freely talk with and engage in personal exchanges with persons in other vehicles.

(e) To provide a means to converse with others and establish interpersonal relationships.

(f) To provide a means of direct person to person talk between occupants of different vehicles.

### BRIEF SUMMARY OF INVENTION

(a) According to the invention, a means of wireless communication embedded in an automobile that allows the vehicle operators to view other vehicles in proximity on a graphics display.

(b) To select a vehicle in proximity, and directly communicate with the driver or other vehicle occupants of that vehicle.

(c) To establish a secure wireless line of communication directly between occupants of different vehicles, while the vehicles are at rest, and/or in motion.

1. (a) graphically displays vehicle proximity data to vehicle operators so that said data is providing a field of choice for inter vehicular communication
(b) whereas said inter vehicular communication is selective
\textcircled{c} whereas said selective communication is direct
whereby said communication device is providing a means for vehicle operators to directly select and communicate between vehicles while vehicles are in motion and at rest.
